(19) United States
(12) Patent Application Publication
(10) Pub. No.: US 2007/0182548 A1
(43) Pub. Date: Aug. 9, 2007

(54) APPARATUS FOR PROVIDING INFORMATION REGARDING A MISSING PERSON TO A MONITORING STATION

(76) Inventor: George Raad, Ottawa, ON (CA)

Correspondence Address: SCHMEISER, OLSEN & WATTS, 22 CENTURY HILL DRIVE, SUITE 302, LATHAM, NY, 12110, US

(21) Appl. No.: 11/622,730

(22) Filed: Jan. 12, 2007

(30) Foreign Application Priority Data
Jan. 12, 2006 (CA) 2,532,958

(51) Int. Cl. G08B 1/08; G08B 23/00

(52) U.S. Cl. 340/539.13; 340/573.4

(57) ABSTRACT

An apparatus and system for locating a person includes a G.P.S. cellular watch removably secured to the person, which acts as a mobile transmitter. When panic buttons on the watch are depressed simultaneously, a location signal is emitted by the watch so that a remote Emergency Control Center (ECC) is informed of the person's location, the panic buttons also automatically starting a photo/video recorder, images from which can be viewed in the ECC, as well as an audio microphone, which allows the ECC to listen, record and save all sounds received by the microphone. The watch face also comprises a security code pad, with a corresponding key pad entry also unique to that apparatus, to lock or unlock the band from the user's wrist, without which entry the apparatus cannot be removed from the person.

This invention relates to a personal monitoring and locating apparatus and system using and incorporating Global Positioning System (GPS) technology to locate missing persons, and more particularly to a cellular wrist watch worn by an individual that is able to emit a GPS location signal to a remote Emergency Control Center, whereby the person's location can be ascertained.

### DESCRIPTION OF THE PRIOR ART

With the continuing problem of locating or ascertaining the whereabouts of missing persons, particularly children, there has been increasing demand for systems which allow parents to monitor the location of their children, particularly in public places. Such systems are also useful for tracking other individuals, such as Alzheimer's patients, who may become disoriented or lost. If the child or the patient becomes separated from the parent or otherwise, several systems have been developed to assist the parent in locating the child. For example, U.S. Pat. No. 5,748,087 (Ingargiola et al) describes a system having a receiver worn by a child or an Alzheimer's patient and a transmitter carried by a parent or a guardian. The parent or guardian may use the transmitter to emit a “find” signal if the child or patient is missing. Upon receipt of the “find” signal, the receiver generates an auditory alarm via speakers and a visual alarm via illuminated LED's. A disadvantage of such a system is that the receiver does not provide location coordinates of the child or patient to the parent or guardian. Consequently, the parent or guardian is required to be within audible or visual range of the alarm in order to locate the child or patient. This process of locating the source of the alarm may be especially difficult in locations having large crowds and a high level of ambient noise or bright lighting.

GPS technology has been used by other systems to provide the location coordinates of a child to a parent or guardian. For example, U.S. Pat. No. 5,742,233 (Hoffman et al), No. 6,031,460 (Banks), No. 6,014,080 (Layson), and No. 5,731,785 (Lemelson et al) describe systems which include a portable GPS receiver for use with a mobile subject such as a child, patient, criminal offender, or a vehicle. The portable GPS receiver receives GPS ranging signals from the GPS satellites and determines its location coordinates from these signals. The GPS receiver then transmits its location coordinates to a central station. The central station makes the location coordinates available to individuals that are interested in locating the child, patient, criminal offender, vehicle, etc. However, there are several shortcomings that are not addressed by the GPS systems known in the art. For example, the calculation of the child's location is performed by a GPS circuit provided in the remote device worn by the child. Providing the capability of determining location in the device worn by the child introduces additional complexity and weight. This additional bulk is especially undesirable when the GPS receiver circuit is worn by a small child.

An additional shortcoming of known systems is the inconvenience of relaying the child's coordinates to a central tracking station. In many instances when a child is likely to become separated from the parent, both the child and the parent are away from home, and therefore typically do not have access to a home computer and/or detailed maps with latitude and longitude coordinates. Without access to such detailed maps, the parent may be unable to relate the child's coordinates, which are provided by the central tracking station, to recognizable geographical features, such as local streets or buildings. Further, known GPS devices which are used to transmit the location of a missing person may become disengaged from the missing person, or may be removed by the apprehender of, for example, a missing child. Accordingly, there exists a need for a portable GPS device, such as a wrist watch, which can emit a GPS location to a remote monitoring unit when activated, and thereby provide the coordinates of a missing person, and which includes a key pad entry locking device, having a unique locking code, entry of which can permit removal of the watch from the person. There further exists a need for such device, which can take and transmit photo, video and audio images and recordings to the remote monitoring unit, to further assist in locating the missing person.

### SUMMARY OF THE INVENTION

It is an object of the present invention to provide an improved device, such as a wrist watch, and system which can emit a GPS location to a remote monitoring unit when activated, and thereby provide the coordinates of a missing person, and which includes a key pad entry locking device, having a unique locking code, entry of which can permit removal of the watch band from the person.

It is another object of the present invention to provide an improved user worn GPS device which can take and transmit photo, video and audio images and recordings to the remote monitoring unit, to further assist in locating the missing person.

According to one aspect of the present invention, there is provided a portable GPS transmitter configured to be mounted to a user comprising activation means for sending, when the activation means is activated, a GPS location signal indicating a position of the user to a remote monitoring unit; video, audio and photo recording means for providing visual and audio recordings from the portable GPS transmitter, the video, audio and photo recording means automatically being activated when the activation means is activated; locking means for removably securing the attachment means of the portable GPS transmitter to the user, the locking means being displaceable only through entry of a locking code unique to the portable GPS transmitter; and attachment means for connecting the portable GPS transmitter to the user, a housing being connected to the attachment means for mounting the activation means, the locking means and the video, audio and photo recording means thereon.

According to another aspect of the present invention, there is provided a watch assembly for being attached to a watchband for extending around a wrist of a user, the watch assembly comprising activation means for sending, when the activation means is activated, a GPS location signal indicating a position of the user to a remote monitoring unit; video, audio and photo recording means for providing visual and audio recordings from the watch assembly, the video, audio and photo recording means automatically being activated when the activation means is activated; and locking means for removably securing the attachment means of the watch assembly, the locking means being displaceable only through entry of a locking code unique to the watch assembly.

According to a still further aspect of the present invention, there is provided a portable GPS transmitter configured to be mounted to a user comprising signal receiving means for receiving an activation signal from a remote monitoring unit and activating the portable GPS transmitter; locking means for removably securing the attachment means of the portable GPS transmitter to the user, the locking means being displaceable only through entry of a locking code unique to the portable GPS transmitter; video, audio and photo recording means for providing visual and audio recordings from the portable GPS transmitter, the video, audio and photo recording means automatically being activated when the activation signal from the remote monitoring unit has been received; GPS signal transmitting means for sending a GPS location signal indicating a position of the user to the remote monitoring unit when the portable GPS transmitter is activated; and attachment means for connecting the portable GPS transmitter to the user, a housing being connected to the attachment means for mounting the signal receiving means, the locking means, the GPS signal transmitting means and the video, audio and photo recording means thereon.

According to yet another aspect of the present invention, there is provided a system for ascertaining the location of a person, comprising a watch assembly for being attached to a watchband for extending around a wrist of a user, the watch assembly comprising activation means for sending, when the activation means is activated, a GPS location signal indicating a position of the user to a remote monitoring unit, and video, audio and photo recording means for providing visual and audio recordings from the watch assembly, and locking means for removably securing the attachment means of the watch assembly, the locking means being displaceable only through entry of a locking code unique to the watch assembly; and a monitoring unit at a location remote from the portable G.P.S. transmitter; whereby, when the activation means is activated, the video, audio and photo recording means automatically begins to forward the visual and audio recordings from the watch assembly to the monitoring unit.

The advantage of the present invention is that it provides an improved device which can emit a GPS location to a remote monitoring unit when activated, and thereby provide the coordinates of a missing person, and which includes a key pad entry locking device, having a unique locking code, entry of which can permit removal of the watch band from the person.

A further advantage of the present invention is that it provides an improved an improved user worn GPS device which can take and transmit photo, video and audio images and recordings to the remote monitoring unit, to further assist in locating the missing person.

### BRIEF DESCRIPTION OF THE DRAWINGS

A preferred embodiment of the present invention is described below with reference to the accompanying drawings, in which:

FIG. 1 illustrates a system for locating missing persons, in accordance with an embodiment of the present invention, and which illustrates the interaction of the Emergency Control Center, the G.P.S portable transmitter and the G.P.S. satellite receiver; and

FIG. 2 illustrates an embodiment of the G.P.S portable transmitter of the present invention, as a wrist watch, to be worn by the user.

### DESCRIPTION OF THE PREFERRED EMBODIMENT

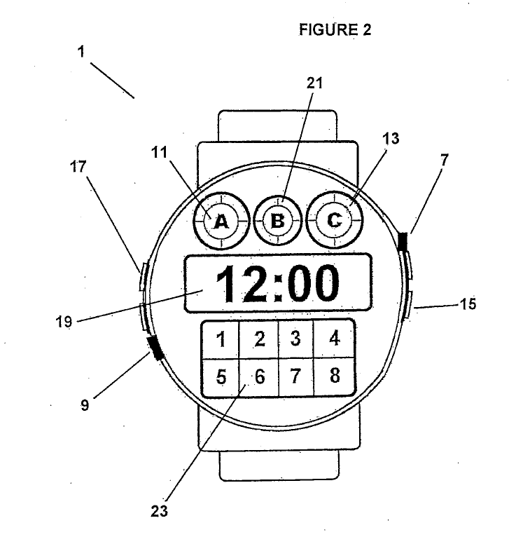

Referring to FIG. 2, there is illustrated an embodiment of the G.P.S portable transmitter 1 of the present invention, as a wrist watch type of device to be worn by the user. Alternatively, a necklace, or other devices (such as an ankle bracelet) known to persons skilled in the art, could also be used to hold the watch (G.P.S portable transmitter) 1 therein. The G.P.S portable transmitter 1, in the form of a watch or the like, is a global positioning device meant to be worn by anyone who is at risk of being lost or kidnapped such as children, teenagers, Alzheimer's patients and so forth. In a preferred embodiment of the present invention, the watch (G.P.S portable transmitter) is waterproof, and will include panic buttons 7, 9, these preferably being spaced apart from one another on opposed sides of the watch face, though other variations as to this positioning are conceivable.

When the panic buttons 7, 9 of the watch 1 are depressed simultaneously, a series of actions are set off at once. First, the watch 1 emits a location signal to notify the Emergency Control Center as to the person's location. It will also automatically start use of the photo/video recorder 11 on the watch face. In a preferred embodiment, the photo/video recorder 11 can take up to 30 still photos every 2 seconds or a video 60 second stream, these being sent at 8 second increments. The photos or video stream can then be viewed instantly in the Emergency Control Center and/or saved in their database. In cases of abduction, of course, these images are obtained in the hope of capturing the assailant's face, or information.

Secondly, when the panic buttons 7, 9 are depressed simultaneously an audio microphone 13 on the watch face is also activated. This feature allows the wearer of the watch to speak directly with the Emergency Control Center (ECC), and allows the ECC to listen to and record all conversations or sounds that are received by the microphone. These, of course, can be saved in the ECC's database.

Power for the watch 1 is supplied by a battery (not shown). The battery can be a long life battery, such as a lithium or similar watch battery. In a further embodiment, it is also noted that the battery may be a rechargeable battery. The watch 1 will preferably have a battery recharge port 15, where the batteries can be recharged (by a charger), if necessary.

With reference to FIG. 2, the watch 1 will further comprise a mode button 17, which allows the wearer to set the clock and alarm for personal use. The watch will, of course, have an LED time display area 19 for presenting the current time, and perhaps date. In a preferred embodiment, the face of the watch 1 will also have a battery power indicator 21 thereon, for illustrating to the wearer how much battery power is left. In a preferred embodiment, the watch 1 will emit a warning light when the battery power has reached ¼ strength, so as to provide an indication as to the need to change the battery or recharge.

Furthermore, the watch 1 also features a unique security code pad 23, whereby the watch band can only be locked and unlocked from the wrist of the wearer, through entry of a PIN number on the security code pad 23 unique to that watch. The advantage of this feature is that it does not permit easy removal of the watch from the wearer. Alternatively, a locking key could also be used to secure and seal the watch band (not shown) to the user.

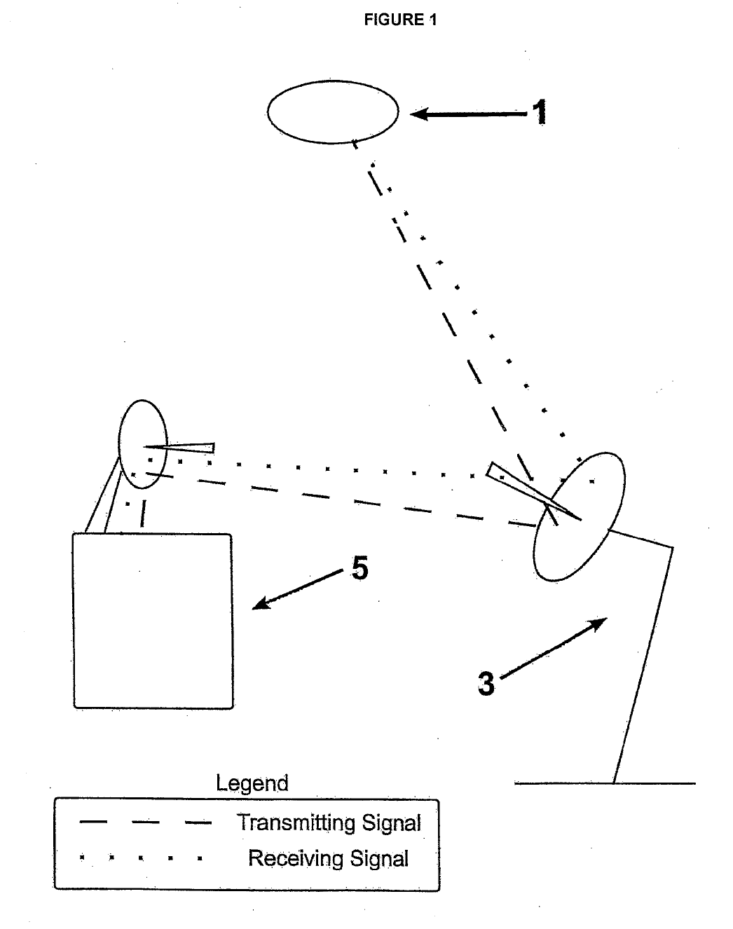

In one alternative embodiment of the present invention, and as shown in FIG. 1, the system for locating a missing person of the present invention comprises a watch 1 removably secured to a person (not shown). The system is supplemented by a G.P.S. satellite receiver 3 which is strategically placed on a purchaser's property. When a person is reported missing, the Emergency Control Center 5 is contacted, whereby the Emergency Control Center 5 sends an activation signal to the G.P. S. satellite receiver 3, which is then forwarded by the G.P. S. satellite receiver 3 to the watch 1, in order to activate the watch 1 to emit a location signal. The location is transmitted by the watch 1 to the G.P.S. satellite receiver 3, which then forwards the location signal on to the Emergency Control Center 5, whereby the missing person can be located. Preferably, the location signal will include a unique identification code identifying the customer based on a customer identification number which is inputted by the customer; when the Emergency Control Center is contacted. After the watch 1 is located and an exact location is determined through the G.P.S. process the proper authorities will be notified and given the location of the missing or lost individual by the Emergency Control Center 5. The Emergency Control Center 5 is the hub of this process. It can enable and disable the watch 1. In a preferred embodiment, the Emergency Control Center 5 will be in a fixed location, though it is conceivable that a mobile Emergency Control Center could also be used.

According to the preferred embodiment of the present invention, any of the location signals from the watch, the signals from the GPS Satellite receiver and the signals from the Emergency Control Center are configured to operate on a radio frequency. According to another embodiment of the present invention, location signals from the watch, the signals from the GPS Satellite receiver and the signals from the Emergency Control Center are configured to operate on a cellular telephone network, and the GPS location signal transmitted by the watch are transmitted on the cellular telephone network.

As noted above, the watch 1 can be activated when the panic buttons 7, 9 on the watch 1 are depressed simultaneously, or when an activation signal is forwarded by the ECC to the watch 1. However, in an alternative embodiment of the present invention, the watch 1 can be activated through the Internet, whereby an access code and password can be entered through use of, for example, a website, wherein an activation signal is forwarded to the watch to ascertain the watch wearer's location.

The present invention has been described herein with regard to preferred embodiments. However, it will be obvious to persons skilled in the art that a number of variations and modifications can be made without departing from the scope of the invention as described herein.

We claim:

1. A portable GPS transmitter configured to be mounted to a user comprising:
activation means for sending, when the activation means is activated, a GPS location signal indicating a position of the user to a remote monitoring unit;
video, audio and photo recording means for providing visual and audio recordings from the portable GPS transmitter, the video, audio and photo recording means automatically being activated when the activation means is activated;
locking means for removably securing the attachment means of the portable GPS transmitter to the user, the locking means being displaceable only through entry of a locking code unique to the portable GPS transmitter; and
attachment means for connecting the portable GPS transmitter to the user, a housing being connected to the attachment means for mounting the activation means, the locking means and the video, audio and photo recording means thereon.

2. The GPS transmitter of claim 1, wherein the activation means further comprises a first panic button and a second panic button, which, when depressed simultaneously, sends the GPS location signal indicating the position of the user to the remote monitoring unit and activates the video, audio and photo recording means.

3. The GPS transmitter of claim 2, wherein the first and the second panic buttons are provided on opposed faces of the housing.

4. A portable GPS transmitter configured to be mounted to a user comprising:
signal receiving means for receiving an activation signal from a remote monitoring unit and activating the portable GPS transmitter;
locking means for removably securing the attachment means of the portable GPS transmitter to the user, the locking means being displaceable only through entry of a locking code unique to the portable GPS transmitter;
video, audio and photo recording means for providing visual and audio recordings from the portable GPS transmitter, the video, audio and photo recording means automatically being activated when the activation signal from the remote monitoring unit has been received;
GPS signal transmitting means for sending a GPS location signal indicating a position of the user to the remote monitoring unit when the portable GPS transmitter is activated; and
attachment means for connecting the portable GPS transmitter to the user, a housing being connected to the attachment means for mounting the signal receiving means, the locking means, the GPS signal transmitting means and the video, audio and photo recording means thereon.

5. The portable GPS transmitter of claim 4, wherein the attachment means used to connect the portable GPS transmitter is an adjustable band having a first end and a second end, whereby the second end of the band can be inserted into and received by the first end of the band to form a connected band around a neck or wrist of the user, the connected band securing the portable GPS transmitter to a wrist or neck of the user.

6. The portable GPS transmitter of claim 1, wherein power for the portable GPS transmitter is supplied by a battery.

7. The portable GPS transmitter of claim 6, wherein the battery is a long life battery.

8. The portable GPS transmitter of claim 7, wherein the long life battery is a lithium or watch battery.

9. The portable GPS transmitter of claim 7, wherein the long life battery is rechargeable.

10. The portable GPS transmitter of claim 1, wherein the GPS portable transmitter, the signal forwarded from the GPS Satellite receiver and the activation signal from the Emergency Control Center are configured to operate on a radio frequency, and the GPS location signal transmitted by the GPS portable transmitter is transmitted on a radio frequency.

11. The portable GPS transmitter of claim 1, wherein the GPS portable transmitter, the signal forwarded from the GPS Satellite receiver and the activation signal from the Emergency Control center are configured to operate on a cellular telephone network, and the GPS location signal transmitted by the GPS portable transmitter is transmitted on the cellular telephone network.

12. A system for ascertaining the location of a person, comprising:
a watch assembly for being attached to a watchband for extending around a wrist of a user, the watch assembly comprising activation means for sending, when the activation means is activated, a GPS location signal indicating a position of the user to a remote monitoring unit, and video, audio and photo recording means for providing visual and audio recordings from the watch assembly, and locking means for removably securing the attachment means of the watch assembly, the locking means being displaceable only through entry of a locking code unique to the watch assembly; and
a monitoring unit at a location remote from the portable G.P.S. transmitter;
whereby, when the activation means is activated, the video, audio and photo recording means automatically begins to forward the visual and audio recordings from the watch assembly to the monitoring unit.

13. The system of claim 12, wherein the GPS location signal is configured to operate on a radio frequency.

14. The portable GPS transmitter of claim 12, wherein the GPS location signal and the visual and audio recordings from the watch assembly are configured to operate on a cellular telephone network.

15. The system of claim 12, wherein the monitoring unit remote from the GPS portable transmitter is a mobile monitoring unit.

16. The system of claim 15, wherein the activation means further comprises a first panic button and a second panic button, which, when depressed simultaneously, sends the GPS location signal indicating the position of the user to the monitoring unit and activates the video, audio and photo recording means.
